(19) United States
(12) Patent Application Publication
(10) Pub. No.: US 2023/0357639 A1
(43) Pub. Date: Nov. 9, 2023

(54) POLE WRAP WITH INTUMESCENT COATING COMPOSITION

(71) Applicant: Hexion Inc., Columbus, OH (US)

(72) Inventors: Mark Clark, Springfield, OR (US); Scott McIntyre, Springfield, OR (US)

(21) Appl. No.: 18/209,841

(22) Filed: Jun. 14, 2023

Related U.S. Application Data
(63) Continuation-in-part of application No. 15/710,671, filed on Sep. 20, 2017, now Pat. No. 10,533,097.

(51) Int. Cl. C09K 21/14; A62C 3/16; C09K 21/02

(52) U.S. Cl. CPC C09K 21/02; A62C 3/16; C09K 21/14

(57) ABSTRACT

Embodiments described herein generally relate to articles, such as pole wraps, comprising an intumescent coating composition. In an embodiment, a wrap for installing on a pole is provided. The wrap includes a substrate, at least a portion of the substrate having a mesh structure. The wrap further includes an intumescent composition disposed over substrate, the intumescent composition comprising one or more expandable graphite compounds. In another embodiment, a wrap for a structure or an installation is provided. In another embodiment, an article is provided and includes a utility pole; and a wrap for covering at least a portion of the utility pole, the wrap comprising: a substrate comprising fiberglass and an elastomer, at least a portion of the substrate having a mesh structure; and an intumescent composition described herein disposed over the substrate.

### RELATED APPLICATION DATA

This application is a continuation in part of U.S. Pat. Application No. 15/710,671, filed on Sep. 20, 2017, and further granted on Jan. 14, 2020 as U.S. Pat. No. 10,533,097, of which the entire contents are incorporated by reference herein.

### FIELD

Embodiments described herein generally relate to articles, such as pole wraps, comprising an intumescent coating composition.

### BACKGROUND

Utility poles, such as power poles, are utilized to support cables, power lines, and wires for the operation of utilities. In many instances, utility poles are made from materials such as wood, metal, concrete, or composite materials that can degrade over time. Pole wraps are utilized to protect portions of utility poles from the effects of weathering, moisture, ultraviolet rays, and fire, as well as other adverse environmental conditions.

Fire resistant coatings can be utilized to protect materials against fire. These coatings do not cause chemical modification of the substrate, but rather the formation of a protective layer which alters the heat flux to the substrate and can inhibit its thermal degradation, ignition, or combustion. Intumescent coatings are commonly used as fire barriers. Intumescent coatings expand under the influence of heat to form a multicellular charred layer which acts as an insulating barrier. The intumesced char can expand up to 50 times the original thickness of the applied coating. It can insulate the substrate and can give additional time before the substrate reaches a temperature at which it loses its load bearing capacity. This extra time can allow for utility structures to remain in place without failure.

There is a need for new and improved pole wraps with, for example, improved resistance to adverse environmental conditions.

### SUMMARY

In an embodiment, a wrap for installing on a pole is provided. The wrap includes a substrate, at least a portion of the substrate having a mesh structure. The wrap further includes an intumescent composition disposed over substrate, the intumescent composition comprising one or more expandable graphite compounds.

Implementations may include one or more of the following. The substrate can comprise a composite material. The substrate can comprise fiberglass and an elastomer. The one or more expandable graphite compounds can comprise a first expandable graphite compound having a mean particle size that is from 300 microns to 1000 microns, a second expandable graphite compound having a mean particle size that is from 0.5 microns to 250 microns, or combinations thereof. The intumescent composition can further comprise: a binder comprising a thermoplastic compound and a thermoset compound, a weight ratio of the thermoplastic compound to the thermoset compound is from 20:1 to 1:3 or from 10:1 to 1:3; a catalyst; and a blowing agent. The one or more expandable graphite compounds can comprise both the first expandable graphite compound and the second expandable graphite compound. A weight ratio of the first expandable graphite compound to the second expandable graphite compound in the intumescent composition can be from 10:1 to 1:10 or from 4:1 to 1:4. A combined amount of the first expandable graphite compound and the second expandable graphite compound in the intumescent composition can be from 1 weight percent to 50 weight percent, based on a total weight of the intumescent composition. An amount of the binder in the intumescent composition can be from 0 weight percent to 80 weight percent, based on a total weight of the intumescent composition. The thermoplastic compound can be selected from the group consisting of polyvinyl acetate, poly(methyl (meth)acrylate), poly(ethyl (meth)acrylate), poly(n-butyl (meth)acrylate), poly(isobutyl (meth)acrylate), poly(tert-butyl (meth)acrylate), poly(2-hydroxyethyl (meth)acrylate), poly (2-hydroxypropyl (meth)acrylate), poly(2-ethylhexyl (meth)acrylate), styrene acrylic and combinations thereof. The thermoset compound can be selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof. The blowing agent can be selected from the group consisting of melamine, urea, butyl urea, alumina trihydrate, magnesium hydroxide, dicyandiamide, benzene sulfonyl-hydrazide, azobisisobutyronitrile, 1,1-azobisformamide, 4,4′oxybis(benzene sulfonhydrazide), dinitroisopentamethylene tetraamine, pentaerythritol, and combinations thereof. An amount of the blowing agent in the intumescent composition can be from 1 weight percent to 20 weight percent, based on a total weight of the intumescent composition. The catalyst can be selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, boric acid, ammonium phosphates, metal phosphates, paratoluene sulfonic acid, and combinations thereof. An amount of the catalyst in the intumescent composition can be from 0.5 weight percent to 20 weight percent, based on a total weight of the intumescent composition.

In another embodiment, a wrap for a structure or an installation is provided. The wrap includes a substrate comprising fiberglass and an elastomer, at least a portion of the substrate having a mesh structure. The wrap further includes an intumescent composition disposed over substrate, the intumescent composition comprising: one or more expandable graphite compounds comprising a first expandable graphite compound having a mean particle size that is from 300 microns to 1000 microns, a second expandable graphite compound having a mean particle size that is from 0.5 microns to 250 microns, or combinations thereof; a binder comprising a thermoplastic compound and a thermoset compound, a weight ratio of the thermoplastic compound to the thermoset compound is from 20:1 to 1:3 or from 10:1 to 1:3; a catalyst; and a blowing agent.

Implementations may include one or more of the following. The one or more expandable graphite compounds can comprise both the first expandable graphite compound and the second expandable graphite compound. A weight ratio of the first expandable graphite compound to the second expandable graphite compound in the intumescent composition can be from 10:1 to 1:10 or from 4:1 to 1:4. A combined amount of the first expandable graphite compound and the second expandable graphite compound in the intumescent composition can be from 1 weight percent to 50 weight percent, based on a total weight of the intumescent composition. An amount of the binder in the intumescent composition can be from 0 weight percent to 80 weight percent, based on a total weight of the intumescent composition; an amount of the blowing agent in the intumescent composition can be from 1 weight percent to 20 weight percent, based on the total weight of the intumescent composition; and/or an amount of the catalyst in the intumescent composition can be from 0.5 weight percent to 20 weight percent, based on the total weight of the intumescent composition. The thermoplastic compound can be selected from the group consisting of polyvinyl acetate, poly(methyl (meth)acrylate), poly(ethyl (meth)acrylate), poly(n-butyl (meth)acrylate), poly(isobutyl (meth)acrylate), poly(tert-butyl (meth)acrylate), poly(2-hydroxyethyl (meth)acrylate), poly (2-hydroxypropyl (meth)acrylate), poly(2-ethylhexyl (meth)acrylate), styrene acrylic, and combinations thereof; the thermoset compound can be selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof; and/or combinations thereof.

In another embodiment, an article is provided. The article includes a utility pole. The article further includes a wrap for covering at least a portion of the utility pole, the wrap comprising: a substrate comprising fiberglass and optionally an elastomer, at least a portion of the substrate having a mesh structure; and an intumescent composition disposed over substrate, the intumescent composition comprising: one or more expandable graphite compounds comprising a first expandable graphite compound having a mean particle size that is from 300 microns to 1000 microns, a second expandable graphite compound having a mean particle size that is from 0.5 microns to 250 microns, or combinations thereof; a binder comprising a thermoplastic compound and a thermoset compound, a weight ratio of the thermoplastic compound to the thermoset compound is from 20:1 to 1:3 or from 10:1 to 1:3; a catalyst; and a blowing agent.

Implementations may include one or more of the following. The one or more expandable graphite compounds comprise both the first expandable graphite compound and the second expandable graphite compound. The intumescent composition can include an intumescent composition described herein.

### BRIEF DESCRIPTION OF THE DRAWINGS

So that the manner in which the recited features of the present disclosure can be understood in detail, a more particular description of the embodiments, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a side view of an article (such as a pole wrap) according to at least one embodiment of the present disclosure.

FIG. 1B is an exploded side view of the article shown in FIG. 1A according to at least one embodiment of the present disclosure.

FIG. 1C shows a top plan view of an example substrate having a mesh, or open-cell, structure that can be used with articles described herein according to at least one embodiment of the present disclosure.

FIG. 2A is a perspective view of a pole to which an article described herein can be installed according to at least one embodiment of the present disclosure

FIG. 2B is a perspective view of a wrap on a pole according to at least one embodiment of the present disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments described herein generally relate to articles, such as pole wraps, comprising an intumescent coating composition. These articles can be fire resistant articles useful for residential and commercial structures, infrastructure, and installations. The articles can include a substrate and a layer (or coating) comprising a fire resistant composition (an intumescent composition). The intumescent composition can help mitigate damage to structures or installations in the event of fire.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

As used herein, the term “coupled” means the joining of two elements directly or indirectly to one another.

Embodiments described herein can be used for utility poles, such as power poles, transmission poles, telephone poles, hydro poles, and telecommunication poles, that are utilized to support cables, power lines, and wires for the operation of utilities. Such utility poles are typically made from materials such as wood, metal, concrete, or composite materials that can degrade over time. Embodiments of articles described herein (such as pole wraps) can be utilized to protect portions of utility poles from the effects of weathering, moisture, ultraviolet rays, and fire, as well as other adverse environmental conditions. Embodiments of articles described herein (such as pole wraps) can be used to protect both the top portion and a face of utility poles.

While embodiments described herein are illustrated with reference to utility poles, various embodiments can be used for any suitable pole, post, piling, column, or other structure or installation which is desired to be protected including both residential and commercial structures, infrastructure, and installations. In addition to protection of utility poles, such applications can include, but are not limited to, fencing, docks, piers, retaining walls, sign poles, house pilings, columns, existing structures and existing infrastructure, among other applications.

The articles can be in the form of a covering such as a wrap, a sleeve, a sheath, a mat, a roll, or the like. The articles can be mounted to, or otherwise attached to, for example, a pole or other structure or installation.

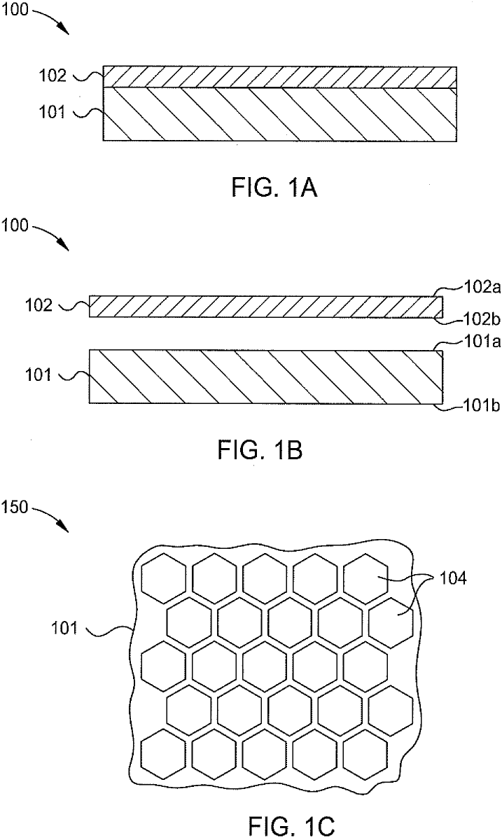

FIG. 1A is a side view of an article 100, and FIG. 1B is an exploded side view of the article shown in FIG. 1A. Articles described herein, for example, the article 100, can be in the form of a multilayer structure such as a laminate, sheet, membrane, or combinations thereof. The article 100 can be in the form of a cured or dried composite. The article 100 can be, for example, fire resistant. As further described below, article 100 can be affixed to a structure or installation, such as a pole or other structure or installation. After installation, the article 100 can provide protection against fire, can prevent or at least mitigate structural damage due to water and moisture.

The article 100 includes a substrate 101 (or base layer) having a first surface 101a and a second surface 101b that is opposite the first surface 101a. Although the substrate 101 is shown as a single layer, the substrate 101 can include one or more layers. The substrate 101 (whether a single layer or multiple layers) can be made of or include any suitable material. Illustrative, but non-limiting, examples of materials useful for at least a portion of substrate 101 can include fiberglass, polymer(s), glass, concrete, foam, plastics, elastomer(s), rubber(s), rubberized asphalt, cellular solid(s), woven fabrics, non-woven fabrics, metal, clay, shale, engineered composite material(s), or combinations thereof, among other materials. Suitable polymers useful as at least a portion of substrate 101 include polyolefins (such as polypropylene and polyethylene), polyvinylacetate, polyacrylate, polyamide, polystyrene, polyester, or their copolymers. The substrate 101 can be flexible or moldable substrate. Alternatively, the substrate 101 can be a rigid substrate. The substrate 101 can be porous or non-porous. In some examples, the substrate can have a mesh structure (or open-cell structure). Alternatively, the substrate 101 can have a closed-cell structure.

In some embodiments, the substrate 101 can be in the form of a scrim, such as a fiberglass scrim or a polyolefin scrim.

As described above, the substrate 101 can have more than one layer. In some embodiments, the more than one layer can include fiberglass, polymer(s), glass, concrete, foam, plastics, elastomer(s), rubber(s), rubberized asphalt, cellular solid(s), woven fabrics, non-woven fabrics, metal, clay, shale, engineered composite material(s), or combinations thereof, among other materials. The layers of the substrate 101 can be the same or different.

In at least one embodiment, a single layer of the substrate 101 can comprise, consist essentially of, or consist of fiberglass and an elastomer (e.g., natural rubber, synthetic rubber, among other elastomers).

The substrate 101 can be a composite material, for example, a reinforced composite material. For example, the substrate 101 can include a polymer, an elastomer, or a rubber, or combinations thereof that is reinforced with a material such as fiberglass, woven fibers, non-woven fibers, metal fibers, ceramic fibers, combinations thereof, among others.

The article 100 further includes a coating 102 (or layer) that comprises, consists essentially of, or consists of, an intumescent composition. The term “fire resistant composition” is interchangeably referred to herein as an “intumescent composition” unless the context clearly indicates otherwise. Intumescent compositions are described below. The coating 102 can be referred to as a fire resistant coating, a fire resistant coating composition, an intumescent coating, or an intumescent coating composition. The coating 102 has a first surface 102a and a second surface 102b opposite the first surface 102a. As shown, the second surface 102b of coating 102 is disposed over, or is adjacent to, the first surface 101a of the substrate 101.

In some examples, the coating 102 can substantially coat, or at least partially coat, at least one surface (for example, first surface 101a or second surface 101b) of the substrate 101. In some examples, an intumescent composition (or a layer that comprises, consists essentially of, or consists of such a composition) can be disposed on multiple surfaces of the substrate 101 and/or within of the substrate 101. For example, when the substrate 101 includes pores, multiple layers, or the like, an intumescent composition, or a coating 102 that comprises, consists essentially of, or consists of such a composition, can be disposed on one or more surfaces, within one or more pores, on or in one or more layers, or combinations thereof, of the substrate 101.

Although one substrate 101 and one coating 102 comprising an intumescent composition are shown, the article 100 can include a plurality of one or both of such layers in any suitable combination. For example, a second coating comprising an intumescent composition (which can be the same or different intumescent composition) can be disposed over, or be adjacent to, the second surface 101b of the substrate 101. Moreover, a plurality of substrates (or base layers) can be used if desired. The number of substrate layers can be the same or different from the number of layers comprising an intumescent composition.

FIG. 1C shows a top plan view 150 of a substrate 101 having a mesh structure that can be used with articles described herein. The mesh structure, or open-cell structure, of the substrate 101 is indicated by voids 104. Although the voids 104 are shown as having a hexagonal shape, the voids 104 can be of any suitable shape, such as circle, oval, square, or other polygon, or combinations thereof, and can be arranged in a random or irregular arrangement. The voids 104 can allow the intumescent to expand and fill the voids 104 when exposed to heat from, for example, a fire. The voids 104 are optional such that the substrate 101 is free of voids, do not have a mesh structure, or do not have an open cell structure. The coating 102, as described above, can be disposed on the mesh structure of the substrate.

Layer(s), coating(s), or combinations thereof, of the multilayer structure can be coupled to or adhered to one another by using suitable materials including, but not limited to, binders and adhesives. The binders and adhesives can act as a binding agent, such as a phenolic resin, or a bonding agent, such as an epoxy resin. Binders and adhesives that are useful include: a hot-melt adhesive; a resin, such as an epoxy resin, a polyvinyl acetate resin, ethylene vinyl acetate copolymer (EVA) resin, a phenolic resin (for example, a phenolformaldehyde resin), an amino resin, a polyurethane resin, an isocyanate-based resin, combinations thereof, among others. The binders, adhesives, or other materials can be dried or cured under ambient conditions; heat, light, electromagnetic radiation, or combinations thereof can be used for drying or curing the binders, adhesives, or other materials. The adhesive or binding agent cures or dries and adheres the one or more layers (or coatings) together. For example, an adhesive, binding agent, or both, can be used to adhere coating 102 to the substrate 101.

Non-limiting, commercially available examples of binders and adhesives include Vinnapas EP 6300 which is a vinyl acetate and ethylene copolymer dispersion available from Wacker Chemie Ag.

In some embodiments, the substrate 101 and the coating 102 can be coupled without the use of an adhesive or a binding agent. For example, the intumescent composition used to form the coating 102 can be introduced to the substrate 101 in a liquid state and upon the curing or drying of the intumescent composition, the coating 102 forms and adheres to substrate 101.

The article 100 can be in the form of a wrap, a sleeve, a mat, a roll, a wall, a siding, a panel, a sheath, or other structure. For example, the article 100 can be a pole wrap. Other applications for the article 100 are contemplated.

If desired, fasteners or clips can be placed onto article 100 to facilitate fastening or mounting to a pole or other structure or installation. Additionally, or alternatively, holes can be disposed in the article 100. The holes can facilitate use of nails or screws to secure the article 100 to a pole or other structure or installation. Additionally, or alternatively, the article 100 is free of fasteners, clips, and holes, and the article 100 is mounted to a pole or other structure or installation at the work site by suitable fasteners.

In use, for example, articles described herein in the form of a wrap, a sheath, a sleeve, a mat, a roll, can be affixed to a pole or other structure or installation that can benefit from fire resistance such as infrastructure equipment, residential building materials and structures, commercial building materials and structures, among other structures and installations.

Embodiments described herein also relate to methods of making articles described herein. Methods of making or forming the articles described herein can include applying a material comprising, or consisting of, an intumescent composition to at least a portion of one or more surfaces of the substrate 101. Here, the material comprising, or consisting of, an intumescent composition can be introduced to, coated on, or otherwise applied to the substrate 101 using any suitable method such as brush coating, spray coating, roller coating, dip coating, curtain coating, and combinations thereof. The substrate 101, having the intumescent composition disposed thereon, can then be cured or dried by suitable methods to form the coating 102. Curing or drying can be performed using suitable methods such as utilizing curing ovens at elevated temperatures. Heating is optional. Curing or drying can be performed at ambient conditions. Additionally or alternatively, other curing and drying methods include, but are not limited to, light, electromagnetic radiation, hot-melt, styrene-acrylics, epoxies, among others. Optionally, adhesives or binders, described above, can be used to secure or otherwise adhere various layers of the article 100.

In some embodiments, the method can include placing fasteners or clips onto the article to facilitate fastening or mounting to a pole or other structure or installation. Additionally, or alternatively, holes can be disposed in the article by suitable methods. The holes can facilitate use of nails or screws to secure the article 100 to a pole or other structure or installation.

In some embodiments, a method for making an article 100 described herein can include forming a layer of an intumescent composition on a surface of the substrate 101. Here the layer of an intumescent composition can be formed by, for example, by coating the substrate 101 using any suitable method such as brush coating, spray coating, roller coating, dip coating, curtain coating, and combinations thereof. The method further include drying or curing the intumescent composition with the substrate to form the article 100. Drying and curing is described above. Further operations, such as adding fasteners, forming holes, among other operations can be performed as described above.

Articles described herein can be pre-formed or pre-fabricated into a variety of shapes such as those used for wrapping poles of commercial and residential structures or installations among other applications. The substrate 101 can be cut into specific dimensions prior to performing the methods. Alternatively, the finished article 100 (for example, as a cured composite comprising the substrate 101 and the coating 102) can be cut into specific dimensions. The article 100 can be produced in the form of a wrap, a sleeve, a sheath, a mat, a roll, or the like. After production of the articles at a manufacturing site, the produced articles can be installed on poles or other structures or installations that can benefit from fire resistance. Installation can be performed at the manufacturing site or at a work site, among other locations.

As described above, the coating 102 can include an intumescent composition. Intumescent compositions are substances that expand as a result of heat exposure, thus increasing in volume and decreasing in density. As described above, the intumescent composition is coated on a substrate to form an article such as a wrap (or other article). When the article is installed on at least a portion of a pole (or other structure or installation), the article can provide resistance to adverse environmental conditions such as, for example, fire. As such, the intumescent compositions provide fire resistance.

The coating 102 can be referred to as an intumescent coating, an intumescent coating composition, a fire resistant coating, or a fire resistant coating composition,

In some embodiments, the intumescent coating composition comprises, consists of, or consists essentially of (a) one or more expandable graphite compounds; (b) a binder comprising i) a thermoplastic compound; and ii) a thermoset compound, with a thermoplastic compound to thermoset compound weight ratio in the range of from 20:1 to 1:3 or from 10:1 to 1:3; (c) a catalyst; and (d) a blowing agent.

The one or more expandable graphite compounds can include a first expandable graphite compound having a mean particle size in the range of from 300 microns to 1000 microns. Additionally, or alternatively, the one or more expandable graphite compounds can include a second expandable graphite compound having a mean particle size in the range of from 0.5 microns to 250 microns, with a first expandable graphite compound. When the first and second expandable graphite compounds are used together, the first expandable graphite compound and the second expandable graphite compound weight ratio can be in the range of from 10:1 to 1:10 or from 4:1 to 1:4.

In some embodiments, the intumescent coating composition comprises, consists of, or consists essentially of (a) a first expandable graphite compound having a mean particle size in the range of from 300 microns to 1000 microns; (b) a second expandable graphite compound having a mean particle size in the range of from 0.5 microns to 250 microns, with a first expandable graphite compound and the second expandable graphite compound weight ratio in the range of from 10:1 to 1:10 or from 4:1 to 1:4; (c) a binder comprising (i) a thermoplastic compound; and (ii) a thermoset compound, with a thermoplastic compound to thermoset compound weight ratio in the range of from 20:1 to 1:3 or from 10:1 to 1:3; (d) a catalyst; and (e) a blowing agent.

Expandable graphite is a synthesized intercalation compound of graphite that expands when heated. Expandable graphite is formed by treating crystalline graphite, which is composed of stacks of parallel planes of carbon atoms, with intercalants such as sulfuric acid and nitric acid. Since no covalent bonding exists between the planes of the carbon atoms, the intercalant can be inserted between them. This allows the intercalant to be positioned within the graphite lattice. When the intercalated graphite is exposed to heat or flame, the inserted molecules decompose and release gases. The graphite layer planes are pushed apart by the gas and the graphite expands up to 300 times its original thickness, its bulk density is lowered, and its surface area is increased. This results in a low-density thermal insulation layer. Expandable graphite can also be referred to as expandable flake graphite, intumescent flake graphite, or expandable flake.

Commercially available examples of expandable graphite include, but are not limited to NYAGRAPH^{®} 35, NYAGRAPH^{®} 251, NYAGRAPH^{®} 351 (NYACOL^{®} Nano Technologies, Inc., Ashland, MA), and GRAFGUARD^{®} 160-50N (Neograf Solutions, Cleveland. OH).

Typically, expandable graphite can be available in a variety of particle size distributions. This varies with the manufacturer and grade. For example, NYAGRAPH^{®} 251 has a particle distribution of the following: below 150 microns - 1-5%, 150 microns -300 microns: 9-15%, 300 microns - 710 microns: 79-85%, and over 710 microns: 1-5%.

The first expandable graphite compound generally has a mean particle size in the range of from 300 microns to 1000 microns. Any and all mean particle size ranges between 300 microns and 1000 microns are included herein and disclosed herein; for example, the first expandable graphite compound can have a mean particle size in the range of from 375 microns to 950 microns, in the range of from 400 microns to 800 microns, or in the range of from 450 microns to 600 microns.

The second expandable graphite compound generally has a mean particle size in the range of from 0.5 microns to 250 microns. Any and all mean particle size ranges between 0.5 microns and 250 microns are included herein and disclosed herein; for example, the second expandable graphite compound can have a mean particle size in the range of from 20 microns to 200 microns, in the range of from 40 microns to 175 microns, or in the range of from 75 microns to 150 microns.

The first expandable graphite compound to second expandable graphite compound weight ratio is generally in the range of from 10:1 to 1:10 or from 4:1 to 1:4. Any and all ranges between 10:1 to 1:10 or from 4:1 and 1:4 are included herein and disclosed herein; for example, the first expandable graphite compound to second expandable graphite compound weight ratio can be in the range of from 10:1 to 1:10, from 3:1 to 1:3, from 2:1 to 1:2, or from 1.5:1 to 1:1.5.

The expandable graphite as a whole (comprising both the first and second expandable graphite compounds), is generally present in the composition in the range of from 1 weight percent to 50 weight percent, based on the total weight of the composition. Any and all ranges between 1 weight percent and 50 weight percent are included herein and disclosed herein; for example, the expandable graphite can be present in the composition in the range of from 5 weight percent to 40 weight percent, or from 5 weight percent to 30 weight percent.

The composition also contains a binder comprising at least one thermoplastic compound and at least one thermoset compound. Binders can perform several functions in intumescent coatings. The binder can act as a matrix in which the other components of the composition are dispersed. The binder can also bind the coating to the substrate. Additionally, the binder can contribute to the insulating char layer formed by the expansion of the composition.

The thermoplastic compound is generally present as a dispersion. The dispersion can be prepared by any suitable method known to those skilled in the art. In various embodiments, the dispersion is prepared via an emulsion.

Examples of thermoplastic compounds that can be used include, but are not limited to polyvinyl acetate, poly(methyl (meth)acrylate), poly(ethyl (meth)acrylate), poly(n-butyl (meth)acrylate), poly(isobutyl (meth)acrylate), poly(tert-butyl (meth)acrylate), poly(2-hydroxyethyl (meth)acrylate), poly (2-hydroxypropyl (meth)acrylate), poly(2-ethylhexyl (meth)acrylate), styrene acrylic, and combinations thereof.

Examples of thermoset compounds that can be used include, but are not limited to phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof.

The thermoset compound is optionally present in the composition as a dispersion. The thermoset dispersion can be prepared by any suitable method known to those skilled in the art.

The binder is generally has a thermoplastic compound to thermoset compound weight ratio in the range of from 20:1 to 1:3 or from 10:1 to 1:3. Any and all weight ratios between 20:1 to 1:3 or between 10:1 and 1:3 are included herein and disclosed herein; for example, the binder can have a thermoplastic compound to thermoset compound weight ratio in the range of from 20:1 to 1:3, from 8:1 to 1:2.5, from 6.5:1 to 1:2, from 6:1 to 1:1.5, or from 5:1 to 1:1.

The binder is generally present in the composition in the range of from 10 weight percent to 80 weight percent. Any and all weight percent ranges from 10 weight percent to 80 weight percent are included herein and disclosed herein; for example, the binder can be present in the composition in the range of from 25 weight percent to 70 weight percent, or from 30 weight percent to 65 weight percent.

Catalysts are useful to assist with the intumescent expansion of the composition. Catalyst examples include, but are not limited to perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, boric acid, ammonium phosphates, metal phosphates, paratoluene sulfonic acid, and combinations thereof.

The catalyst is generally present in the composition in the range of from 0.5 weight percent to 20 weight percent, based on the total weight of the composition. Any and all ranges between 0.5 weight percent and 20 weight percent are included herein and disclosed herein; for example, the catalyst can be present in the composition in the range of from 1 weight percent to 15 weight percent, or from 2 weight percent to 10 weight percent.

The composition also contains a blowing agent. The blowing agent is useful for expanding the binder in order to increase the thickness of the composition. The blowing agent can also dilute the concentrations of combustible gasses that are released when a wood substrate burns. Examples of blowing agents that can be used include, but are not limited to melamine, urea, butyl urea, alumina trihydrate, magnesium hydroxide, dicyandiamide, benzene sulfonyl-hydrazide, azobisisobutyronitrile, 1,1-azobisformamide, 4,4′oxybis(benzene sulfonhydrazide), dinitroisopentamethylene tetraamine, pentaerythritol, and combinations thereof. In various embodiments, the melamine used can be Melafine® by OCI Nitrogen.

The blowing agent is generally present in the composition in the range of from 1 weight percent to 20 weight percent, based on the total weight of the composition. Any and all ranges between 1 weight percent and 20 weight percent are included herein and disclosed herein; for example, the blowing agent can be present in the composition in the range of from 2 weight percent to 15 weight percent, or from 3 weight percent to 10 weight percent.

The composition can also contain a wide variety of optional components. Such optional components include, but are not limited to toxic gas absorbing materials, absorbent promoters, wetting agents, nucleating agents, accelerators, fillers, buffers, reinforcing additives, surfactants, pigments, defoamers, and thickeners.

To prepare the composition, the expandable graphite, catalyst, blowing agent, thermoplastic compound, and thermoset compound are mixed together in any order, combination, or sub-combination. Optional components can also be added to the mixture.

The intumescent coating composition can be used to coat substrates, particularly wood substrates such as solid lumber, particle board, plywood, medium density fiberboard, hardboard, parallel strand lumber, oriented strand board, and strawboard. The intumescent coating composition can be coated to the substrate in any suitable manner. Examples of coating methods include, but are not limited to brush coating, spray coating, roller coating, and curtain coating. If desired, the composition can be used in combination with other fire-retardant systems. The composition can be used in residential and commercial applications such as roofing, walls, floors, I-joists, underlayment, sheathing, and siding.

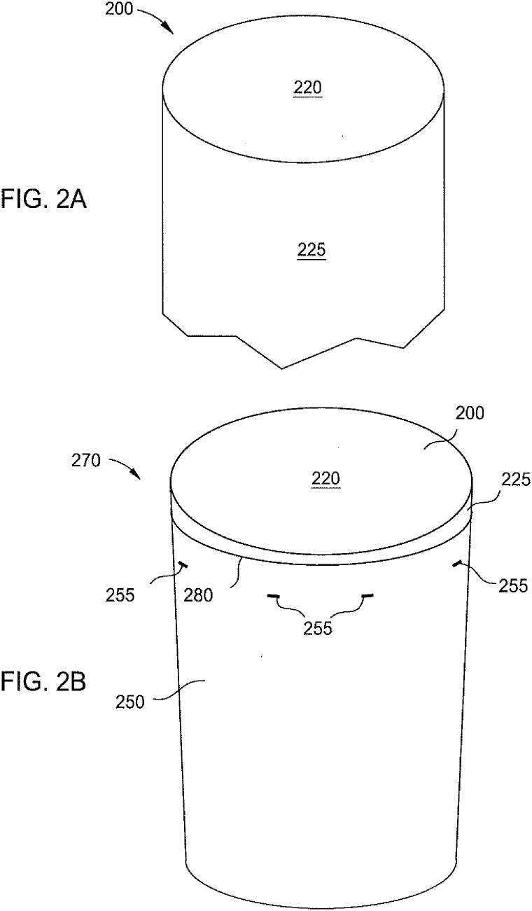

FIG. 2A is a perspective view of the pole 200 to which an article described herein can be installed according to at least one embodiment of the present disclosure. FIG. 2B is a perspective view of a wrap 250 (for example, article 100) installed on the pole 200 according to at least one embodiment of the present disclosure. A sheath, a sleeve, a mat, a roll, or other structure can be used as an alternative to the wrap 250. Although the illustrations of FIGS. 2A and 2B show the pole 200 as cylindrical, the wrap 250 described herein can fit a variety of shapes and sizes of poles. The wrap 250 installed on pole 200 can be an article of manufacture 270. The wrap 250 (or sheath, sleeve, mat, roll, or other structure) can include, or be made from, a substrate (for example, substrate 101) and an intumescent composition (for example, coating 102 comprising an intumescent composition).

Referring to FIG. 2A, the pole 200 includes a pole end 220 and a pole face 225. The wrap 250 can be installed on a face of the pole 200, and can extend along a whole length of the pole 200 or a portion of the pole 200. Although not shown, the wrap 250 can cover at least a portion of the pole end 220. The wrap 250 can be bended, folded, molded, plied, or otherwise deformed in order to, for example, cover a portion of a pole or other structure or installation.

The wrap 250 can be layered around the pole one or more times. The wrap 250 can be secured to, mounted to, fastened to, coupled to, or otherwise installed on, the pole 200 by a fastener 255 such as a staple, a nail, a screw, a clip, a pin, a rivet, a bolt, an anchor, or combinations thereof, among other fasteners. Additionally, or alternatively, the wrap 250 can be secured to, mounted to, fastened to, coupled to, or otherwise installed on, the pole 200 by use of a suitable adhesive. In some embodiments, a wrap end 280 of the wrap 250 can be positioned under the pole end 220. In other embodiments, the wrap end 280 of the wrap 250 can extend over at least a portion of the pole end 220.

The wrap 250 can be secured to the pole 200 prior to installation of the pole 200 at a work site. Alternatively, the wrap 250 can be secured to a pole 200 that is already installed at the work site, for example, a pole 200 that is already installed in the ground.

In some embodiments, which can be combined with other embodiments, the wrap 250 can be used with a pole cap (not shown) that covers at least a portion of the pole end 220. The wrap 250 can be disposed between the pole 200 and the pole cap. Alternatively, the pole cap can be disposed between the pole 200 and the wrap 250.

### EXAMPLES

In order that those skilled in the art may more fully understand embodiments presented herein, the following procedures and examples are set forth. The components used included the following:

DISPERBYK-190: a dispersing additive for aqueous coating systems, supplied by BYK Additives & Instruments.

Nyacol^{®} Nyagraph 251: expandable graphite supplied by Nano Technologies, Inc. Its typical particle size distribution is: below 150 µm: 1-5%, 150 µm - 300 µm: 9-15%, 300 µm - 710 µm: 79-85%, and over 710 µm: 1-5%.

Nyacol^{®} Nyagraph 35: expandable graphite supplied by Nano Technologies, Inc. Its typical particle size distribution is: below 45 µm: 15-25%, 45 µm - 75 µm: 20-25%, 75 µm - 150 µm: 35-50%, 150 µm - 180 µm: 9-15%, 180 µm - 300 µm: 1-5%, and over 300 µm: 0%.

Melafine^{®}: melamine with particle size of less than 40 microns, supplied by OCI Nitrogen.

Exolit AP 422: a fine-particle ammonium polyphosphate, supplied by Clariant.

BYK-037: a volatiles-free, silicone-containing defoamer based on mineral oil, supplied by BYK Additives & Instruments.

Natrosol™ 250 HR: a thickener supplied by Ashland Specialty Chemical.

Multibond 1P2: a crosslinking polyvinyl acetate supplied by Franklin Adhesives and Polymers.

XB-91MO: a phenolic thermoset compound supplied by Hexion Inc.

NX 795: coalescing agent (coal. agent) for latex formulations, supplied by Perstorp.

Thixol 53L: a liquid acrylic thickener supplied by Coatex.

Rheotech™ 3800: a thickener supplied by Coatex.

The components used in the intumescent coating formulation Examples 1-4 are shown in Tables 1-4, below.

TABLE 1

Formulation for Intumescent Coating - Comparative

| Example 1 | | |
|---|---|---|
| | Ingredients | Parts by weight |
| | Part I | |
| Water | Water | 19.8 |
| Dispersant | Disperbyk 190 | 0.84 |
| Pigment | Calcium Carbonate | 8.36 |
| Expandable graphite | Nyagraph 251 | 16.72 |
| Blowing agent | Melafine | 4.18 |
| Catalyst | Exolit AP 422 | 8.36 |
| Defoamer | Byk 037 | 0.21 |
| Thickener | Natrosol Hr 250, 2 % | 0.2 |
| | Part II | |
| Water | Water | 3.40 |
| Binder | Multibond 1P2 | 34.65 |
| Coal. agent | NX 795 | 1.09 |
| Water softener | Sodium Polyphosphate, 10% | 0.63 |
| Thickener | Thixol 53L | 1.00 |

TABLE 2

Formulation for Intumescent Coating - Comparative

| Example 2 | | |
|---|---|---|
| | Ingredients | Parts by weight |
| | Part I | |
| Water | Water | 19.8 |
| Dispersant | Disperbyk 190 | 0.84 |
| Pigment | Calcium Carbonate | 8.36 |
| Expandable graphite | Nyagraph 251 | 16.72 |
| Blowing agent | Melafine | 4.18 |
| Catalyst | Exolit AP 422 | 8.36 |
| Defoamer | Byk 037 | 0.21 |
| Thickener | Natrosol Hr 250, 2 % | 0.2 |
| | Part II | |
| Water | Water | 3.40 |
| Binders | Multibond 1P2 | 28.96 |
| | XB-91MO | 7.27 |
| Coal. agent | NX 795 | 1.09 |
| Water softener | Sodium Polyphosphate, 10% | 0.63 |
| Thickener | Thixol 53L | 1.00 |

TABLE 3

Formulation for Intumescent Coating - Comparative

| Example 3 | | |
|---|---|---|
| | Ingredients | Parts by weight |
| | Part I | |
| Water | Water | 19.8 |
| Dispersant | Disperbyk 190 | 0.84 |
| Pigment | Calcium Carbonate | 8.36 |
| Expandable graphite | Nyagraph 251 | 8.36 |
| | Nyagraph 35 | 8.36 |
| Blowing agent | Melafine | 4.18 |
| Catalyst | Exolit AP 422 | 8.36 |
| Defoamer | Byk 037 | 0.21 |
| Thickener | Natrosol Hr 250, 2 % | 0.2 |
| | Part II | |
| Water | Water | 3.40 |
| Binder | Multibond 1P2 | 34.65 |
| Coal. agent | NX 795 | 1.09 |
| Water softener | Sodium Polyphosphate, 10% | 0.63 |
| Thickener | Thixol 53L | 1.00 |

TABLE 4

Formulation for Intumescent Coating - Inventive

| Example 4 | Ingredients | Parts by weight |
|---|---|---|
| | Part I | |
| Water | Water | 19.8 |
| Dispersant | DISPERBYK 190 | 0.84 |
| Pigment | Calcium Carbonate | 8.36 |
| Expandable graphite | Nyagraph 251 | 8.36 |
| | Nyagraph 35 | 8.36 |
| Blowing agent | Melafine | 4.18 |
| Catalyst | Exolit AP 422 | 8.36 |
| Defoamer | BYK037 | 0.21 |
| Thickener | Natrosol 250 HR, 2 % | 0.2 |
| | Part II | |
| Water | Water | 3.40 |
| Binders | Covinax 707 | 28.96 |
| | XB-91MO | 7.27 |
| Coal. agent | NX 795 | 1.09 |
| Water softener | Sodium Polyphosphate, 10% | 0.63 |
| Thickener | Thixol 53L | 1.00 |

### Preparation of Formulations

The materials from Part I were charged to a vessel while mixing. The mixture was covered with plastic or wax paper and was allowed to stand for one hour for the mixture to reach equilibrium. The mixture was then gently mixed to form a suspension. The suspension was then ground using a Dispermat at 3500 rpm for 20 minutes. After the grinding was completed, the materials from Part II were then charged to the vessel while mixing. The pH and viscosity were then measured. If necessary, the pH was adjusted to above 8.5. The mixture was then thickened with Rheotech 3800 rheology improver to achieve the desired thickness.

### Testing

OSB boards (43 inches × 43 inches) were coated with the intumescent coating using draw-down or spray coating methods The coated boards were air dried to the touch and then put into an oven at 60° C. for 2-12 hours in order to cure the thermoset component in the coating.

The coated boards were tested for effectiveness using the ASTM E1623 test method. The results are shown in Table 5, below.

TABLE 5

Comparison of Burn-Through Time Between Different Intumescent Coating Formulations

| Sample | Coating formulation | | Time to burn-through (minutes) | Char layer thickness (inch) | Char layer detached from substrate | Pass or fail (minimum burn-through time 40 minutes) |
|---|---|---|---|---|---|---|
| | Expandable graphites | Polymeric binder | | | | |
| Example 1 | One size | Polyvinyl Acetate | 13 | 1.5 | Yes | Fail |
| Example 2 | One size | Polyvinyl Acetate & Phenolic blend | 26 | 1.5 | No | Fail |
| Example 3 | Two different particle sizes blended | Polyvinyl Acetate | 28 | 1.5 | Yes | Fail |
| Example 4 | Two different particle sizes blended | Polyvinyl Acetate & Phenolic blend | 58 | 1.5 | No | Pass |

As can be seen in Table 5 above, Example 4 had the highest time to burn-through and was also the only coating formulation that was able to meet the minimum standard of 40 minutes to burn-through.

Embodiments described herein generally relate to articles, such as pole wraps, comprising an intumescent coating composition. The articles can provide fire resistance to poles or other structures or installations that can benefit from fire resistance.

Articles of the invention, in the form of protective utility pole wraps, were tested on Western Red Cedar (WRC) pole sections treated with chromium copper arsenate (CCA) following the exposure methodology similar to proposed ASTM standard WK 633252 “Standard Test method for determining of charring depth of wood utility poles exposed to simulated wildland fires,” which evaluates performance via a 10-minute radiant panel, impinging flame and post-test wind exposure. The matched pole sections were cut into 18 inch lengths and tested by a 10-minute 90,000 BTU, 1080° C. (1975° F.) radiant panel exposure at 9″ distance from the specimen surface with 3 additional 10,000 BTU supporting flame burners during the final 5 minutes of the test period. The sections were monitored by 9 thermocouples (TC) on the sections with grooves cut to house the TC leads. Ceramic fiber was used to lock the TC into place and to ensure they were flush with the pole section surface. Subsequent to burning, the sections were exposed to fan generated wind at 2 m/s until all thermocouples registered below 50° C. Prior to testing the sections were conditioned for one month at indoor ambient conditions to equalize the moisture content (MC%) throughout the specimen. Poles sections with a single wrap and with a double wrap were tested against an unprotected un-wrapped section. The results are shown in Table 6 below.

TABLE 6

Comparison between protected and unprotected pole sections

| CCA treated Western Red Cedar Wrapped vs. Unprotected Fire Test | | | | | | |
|---|---|---|---|---|---|---|
| ID/Treatment | Maximum Single TC Reading (°C) | Elapsed Time above 400° C. threshold | Elapsed Time from Exposure end to 50° C. (mm:ss) | Char Depth (in) | Elapsed Time from Exposure end to Surface Flame ceased (mm:ss) | Specimen Mass Loss % |
| Example 5 Double Wrap | 381.8 | 0:00 | 14:45 | Minimal | 0:18 | 0.8 |
| Example 6 Single Wrap | 535.4 | 3:01 | 12:14 | ⅛ | 0:22 | 1.52 |
| Comparative Example 7 Unprotected | 823.9 | 6:53¹ | 7:55 | ⅝+ | 131:15 | 11.87 |

¹ Wind exposure rapidly cooled TC below 50° C. while specimen continued to ember.

As can be seen in Table 6 above, Examples 5 and 6 of the invention exhibited reduced char depth and mass loss % when compared to unwrapped Example 7. In the protected sections the char depth was not sufficient to contribute to the failure of a pole in service. In addition, the protected sections began to cool immediately upon termination of the burn with the activated wrap creating a seal against exposure of the wood to oxygen during the wind exposure. In contract, the unprotected pole continued to ember and smolder losing almost 12% of mass with damage reaching the sections center. Articles of the invention, in the form of protective utility pole wraps, were also tested on Southern Yellow Pine (SYP) pole sections treated with CCA. The results are shown in Table 7 below.

TABLE 7

Comparison between protected and unprotected pole sections

| CCA treated Yellow Pine: Wrapped vs Unprotected Fire Test | | | | | | Apr. 27, 2021 |
|---|---|---|---|---|---|---|
| ID/Treatment | Maximum Single TC Reading (°C) | Elapsed Time above 400° C. threshold | Elapsed Time from Exposure end to 50° C. (mm:ss) | Char Depth (in) | Elapsed Time from Exposure end to Surface Flame ceased (mm:ss) | Specimen Mass Loss % |
| Example 8 Single Wrap | 308.8 | 0:00 | 5:56 | Minimal | No Flame | 0.47 |
| Comparative Example 9 Unprotected | 854.3 | 8:01 | 0:45¹ | ⅛ | 176:36² | 63.3 |

¹ Wind exposure rapidly cooled TC below 50° C. while specimen continued to ember.
² Remainder of specimen fell off stand at the 2:56:36 mark and was extinguished.

While embodiments of the present disclosure have been described and illustrated by reference to particular embodiments and examples, those of ordinary skill in the art will appreciate that embodiments described herein lend itself to variations not necessarily illustrated herein.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a thermoplastic compound” includes aspects comprising one, two, or more thermoplastic compounds, unless specified to the contrary or the context clearly indicates only one thermoplastic compound is included.

While the foregoing is directed to aspects of the present disclosure, other and further aspects of the disclosure may be devised without departing from the basic scope thereof, and the scope thereof is determined by the claims that follow.

What is claimed is:

1. A wrap for installing on a pole, the wrap comprising:
a substrate, at least a portion of the substrate having a mesh structure; and
an intumescent composition disposed over the substrate, the intumescent composition comprising one or more expandable graphite compounds.

2. The wrap of claim 1, wherein the substrate comprises fiberglass and optionally an elastomer.

3. The wrap of claim 1, wherein:
the one or more expandable graphite compounds comprising a first expandable graphite compound having a mean particle size that is from 300 microns to 1000 microns, a second expandable graphite compound having a mean particle size that is from 0.5 microns to 250 microns, or combinations thereof; and
the intumescent composition further comprises:
a binder comprising a thermoplastic compound and a thermoset compound, a weight ratio of the thermoplastic compound to the thermoset compound is from 20:1 to 1:3;
a catalyst; and
a blowing agent.

4. The wrap of claim 3, wherein the one or more expandable graphite compounds comprises both the first expandable graphite compound and the second expandable graphite compound.

5. The wrap of claim 4, wherein a weight ratio of the first expandable graphite compound to the second expandable graphite compound in the intumescent composition is from 10:1 to 1:10.

6. The wrap of claim 4, wherein a combined amount of the first expandable graphite compound and the second expandable graphite compound in the intumescent composition is from 1 weight percent to 50 weight percent, based on a total weight of the intumescent composition.

7. The wrap of claim 3, wherein an amount of the binder in the intumescent composition is from 0 weight percent to 80 weight percent, based on a total weight of the intumescent composition.

8. The wrap of claim 3, wherein:
the thermoplastic compound is selected from the group consisting of polyvinyl acetate, poly(methyl (meth)acrylate), poly(ethyl (meth)acrylate), poly(n-butyl (meth)acrylate), poly(isobutyl (meth)acrylate), poly(tert-butyl (meth)acrylate), poly(2-hydroxyethyl (meth)acrylate), poly (2-hydroxypropyl (meth)acrylate), poly(2-ethylhexyl (meth)acrylate), styrene acrylic, and combinations thereof;
the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof; or
combinations thereof.

9. The wrap of claim 3, wherein the blowing agent is selected from the group consisting of melamine, urea, butyl urea, alumina trihydrate, magnesium hydroxide, dicyandiamide, benzene sulfonyl-hydrazide, azobisisobutyronitrile, 1,1-azobisformamide, 4,4′oxybis(benzene sulfonhydrazide), dinitroisopentamethylene tetraamine, pentaerythritol, and combinations thereof.

10. The wrap of claim 3, wherein an amount of the blowing agent in the intumescent composition is from 1 weight percent to 20 weight percent, based on a total weight of the intumescent composition.

11. The wrap of claim 3, wherein the catalyst is selected from the group consisting of perchloric acid, hydroiodic acid, hydrobromic acid, sulfuric acid, hydrochloric acid, nitric acid, sulfurous acid, phosphoric acid, nitrous acid, sulfonic acid, hydrochloric acid, sulfuric acid, phosphoric acid, formic acid, acetic acid, maleic acid, malic acid, tartaric acid, citric acid, boric acid, ammonium phosphates, metal phosphates, paratoluene sulfonic acid, and combinations thereof.

12. The wrap of claim 3, wherein an amount of the catalyst in the intumescent composition is from 0.5 weight percent to 20 weight percent, based on a total weight of the intumescent composition.

13. A wrap for a structure or an installation, the wrap comprising:
a substrate comprising fiberglass and an elastomer, at least a portion of the substrate having a mesh structure; and
an intumescent composition disposed over the substrate, the intumescent composition comprising:
one or more expandable graphite compounds comprising a first expandable graphite compound having a mean particle size that is from 300 microns to 1000 microns, a second expandable graphite compound having a mean particle size that is from 0.5 microns to 250 microns, or combinations thereof;
a binder comprising a thermoplastic compound and a thermoset compound, a weight ratio of the thermoplastic compound to the thermoset compound is from 20:1 to 1:3;
a catalyst; and
a blowing agent.

14. The wrap of claim 13, wherein the one or more expandable graphite compounds comprises both the first expandable graphite compound and the second expandable graphite compound.

15. The wrap of claim 14, wherein a weight ratio of the first expandable graphite compound to the second expandable graphite compound in the intumescent composition is from 10:1 to 1:10.

16. The wrap of claim 14, wherein a combined amount of the first expandable graphite compound and the second expandable graphite compound in the intumescent composition is from 1 weight percent to 50 weight percent, based on a total weight of the intumescent composition.

17. The wrap of claim 14, wherein:
an amount of the binder in the intumescent composition is from 0 weight percent to 80 weight percent, based on a total weight of the intumescent composition;
an amount of the blowing agent in the intumescent composition is from 1 weight percent to 20 weight percent, based on the total weight of the intumescent composition; and
an amount of the catalyst in the intumescent composition is from 0.5 weight percent to 20 weight percent, based on the total weight of the intumescent composition.

18. The wrap of claim 14, wherein:
the thermoplastic compound is selected from the group consisting of polyvinyl acetate, poly(methyl (meth)acrylate), poly(ethyl (meth)acrylate), poly(n-butyl (meth)acrylate), poly(isobutyl (meth)acrylate), poly(tert-butyl (meth)acrylate), poly(2-hydroxyethyl (meth)acrylate), poly (2-hydroxypropyl (meth)acrylate), poly(2-ethylhexyl (meth)acrylate), styrene acrylic, and combinations thereof;
the thermoset compound is selected from the group consisting of phenol formaldehyde, urea formaldehyde, melamine formaldehyde, melamine reinforced urea formaldehyde, isocyanate reinforced urea formaldehyde resin, resorcinol formaldehyde resin, polyacrylic latex resin, isocyanate resin, an organopolysiloxane, ethylene glycol, bisphenol-A epoxy resins, bisphenol-F epoxy resins, unsaturated polyesters, and combinations thereof; or
combinations thereof.

19. An article, comprising:
a utility pole; and
a wrap for covering at least a portion of the utility pole, the wrap comprising:
a substrate comprising fiberglass and an elastomer, at least a portion of the substrate having a mesh structure; and
an intumescent composition disposed over the substrate, the intumescent composition comprising:
one or more expandable graphite compounds comprising a first expandable graphite compound having a mean particle size that is from 300 microns to 1000 microns, a second expandable graphite compound having a mean particle size that is from 0.5 microns to 250 microns, or combinations thereof;
a binder comprising a thermoplastic compound and a thermoset compound, a weight ratio of the thermoplastic compound to the thermoset compound is from 20:1 to 1:3;
a catalyst; and
a blowing agent.

20. The article of claim 19, wherein the one or more expandable graphite compounds comprises both the first expandable graphite compound and the second expandable graphite compound.
